(19) United States
(12) Patent Application Publication
(10) Pub. No.: US 2007/0213098 A1
(43) Pub. Date: Sep. 13, 2007

(54) Apparatus and method for transmitting signal in wireless communication system

(75) Inventors: Sang-Hoon Sung, Suwon-si (KR); Yong-Seok Kim, Suwon-si (KR); Young-Hoon Kwon, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/708,657

(22) Filed: Feb. 20, 2007

(30) Foreign Application Priority Data
Feb. 20, 2006 (KR) 16284-2006

(51) Int. Cl. H04M 1/00

(52) U.S. Cl. 455/562.1

(57) ABSTRACT

An apparatus and a method for transmitting a signal in a wireless communication system are disclosed. A method for transmitting a signal by a Base Station (BS) in a wireless communication system includes estimating an uplink channel using a signal received from a Mobile Station (MS), determining a beam coefficient for each of sub-carriers constituting a predetermined frequency band based on the estimated uplink channel, forming a beam for the predetermined frequency band by multiplying each sub-carrier by the beam coefficient, and transmitting a signal using the formed beam.

### PRIORITY

This application claims priority under 35 U.S.C. § 119(a) of a Korean Patent Application filed in the Korean Intellectual Property Office on Feb. 20, 2006 and assigned Serial No. 2006-16284, the contents of which are incorporated herein by reference.

### BACKGROUND OF THE INVENTION

1. Field of the Invention

The present invention relates generally to a wireless communication system, and in particular, to an apparatus and method for transmitting a signal to improve signal reception performance.

2. Description of the Related Art

A smart antenna technology is designed to improve the performance of a transmitter or a receiver by using a plurality of antennas in the transmitter or the receiver in a wireless communication system. A Base Station (BS) provides a separate beam to each Mobile Station (MS) in a cell using a smart antenna. In other words, the BS forms a beam towards a destination MS in such a manner as to maximize a gain and forms a beam towards other MSs in such a manner as to minimize a gain. Accordingly, the destination MS can receive a signal having minimal additive noise.

There are two methods for improving signal reception performance using a smart antenna: one is a diversity method and the other is a beamforming method. The diversity method overcomes multi-path fading using a spatial or temporal interval between signal transmissions. The beamforming method provides a directional beam pattern to an MS by changing a weight applied to a smart antenna.

In the wireless communication system, an MS can perform normal signal transmission/reception only when it has no problem in receiving a signal of a BS, e.g., a broadcasting message. However, an MS in a cell boundary region may fail to receive a downlink broadcasting message even if the BS uses a robust Modulation and Coding Scheme (MCS) level for the MS.

### SUMMARY OF THE INVENTION

An aspect of the present invention is to address at least the above problems and/or disadvantages and to provide at least the advantages described below. Accordingly, an aspect of the present invention is to provide an apparatus and method for transmitting a signal to minimize an interference signal from an adjacent Base Station (BS) in a wireless communication system.

Another aspect of the present invention is to provide a cell planning method to minimize an interference signal from an adjacent Base Station (BS) in a wireless communication system.

According to an aspect of the present invention, there is provided a method for transmitting a signal by a Base Station (BS) in a wireless communication system. The method includes estimating an uplink channel using a signal received from a Mobile Station (MS), determining a beam coefficient for each of sub-carriers constituting a predetermined frequency band based on the estimated uplink channel, forming a beam for the predetermined frequency band by multiplying each sub-carrier by the beam coefficient, and transmitting a signal using the formed beam.

According to another aspect of the present invention, there is provided a method for planning a beam in a wireless communication system in which a cell is divided into at least two sectors. The method includes dividing the entire frequency band into a predetermined number of N frequency bands, estimating an uplink channel using a signal received from a Mobile Station (MS), determining a beam coefficient for each of sub-carriers of each of the N frequency bands used in a first sector based on the estimated uplink channel and forming N beams in the first sector by multiplying each sub-carrier by the beam coefficient, and forming beams in a second sector by shifting the N beams by a predetermined frequency band in a frequency domain.

### BRIEF DESCRIPTION OF THE DRAWINGS

The above and other features and advantages of an exemplary embodiment of the present invention will become more apparent from the following detailed description taken in conjunction with the accompanying drawings, in which:

FIG. 1 is a block type diagram illustrating the structure of a Base Station (BS) transmitter for clustered beamforming in a wireless communication system according to an exemplary embodiment of the present invention;

FIGS. 2A through 2C are views for explaining transmission of a clustered-beamformed signal according to an exemplary embodiment of the present invention;

FIGS. 3A and 3B are views for explaining a beam cell planning method in a wireless communication system according to an exemplary embodiment of the present invention;

FIG. 4 is a view for explaining an example of a beam cell planning method according to an exemplary embodiment of the present invention; and

FIG. 5 is a flowchart illustrating a process in which a BS transmits a signal using clustered beamforming according to an exemplary embodiment of the present invention.

### DETAILED DESCRIPTION OF THE EXEMPLARY EMBODIMENT

An exemplary embodiment of the present invention will now be described in detail with reference to the accompanying drawings. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

According to the present invention, a Base Station (BS) forms a beam in units of at least one sub-carrier to transmit a downlink signal to a Mobile Station (MS) in a wireless communication system. To this end, the present invention provides a new beam cell planning method capable of improving a Carrier-to-Interference ratio (C/I). Here, a unit of at least one sub-carrier may be a tile of bin used in an Institute of Electrical and Electronics Engineers (IEEE) 802.16 communication system. The tile or bin indicates a resource allocation unit composed of at least one sub-carrier. The downlink signal may be broadcasting information broadcasted by a plurality of BSs.

The present invention can be applied to all types of communication systems that have cell without sector and cell with a plurality of sectors.

Hereinafter, a unit composed of at least one tile or bin will be referred to as a clustered unit and clustered-unit based beamforming will be referred to as clustered beamforming. However, the clustered unit may also be composed of at least one sub-carrier, without being limited to tiles or bins.

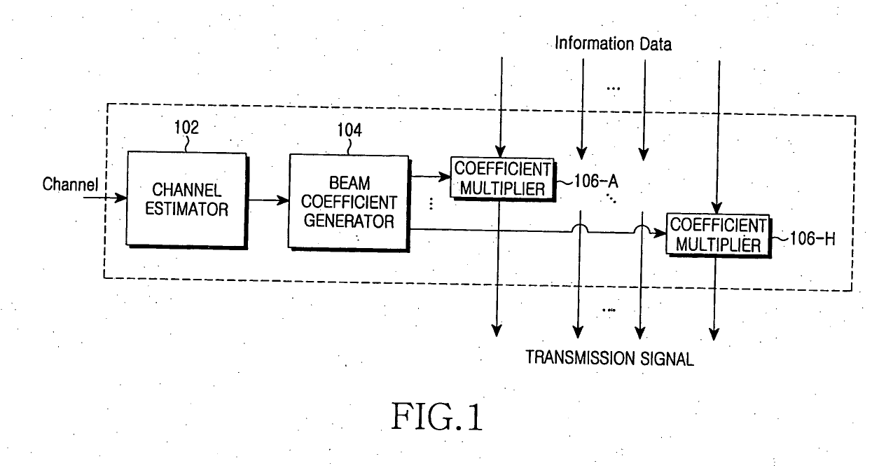

FIG. 1 is a block type diagram illustrating the structure of a BS transmitter for clustered beamforming in a wireless communication system according to an exemplary embodiment of the present invention.

Referring to FIG. 1, a channel estimator 102 of the BS estimates an uplink channel using a signal received from the MS and outputs the estimated channel information to a beam coefficient generator 104. Here, the uplink channel may be estimated by channel estimation using headroom information or channel estimation using an uplink pilot signal, which falls outside the scope of the present invention and thus will not be described. The beam coefficient generator 104 determines an optimal beam coefficient that minimizes an interference signal from an adjacent BS, generates the determined beam coefficient, and outputs the generated beam coefficient to coefficient multipliers 106-A through 106-H. The beam coefficient is used to determine a beam size and a way of determining the beam coefficient according to the present invention is different from a conventional way. In other words, a beam coefficient is determined for the entire frequency band according to the conventional art, but a beam coefficient is determined for a predetermined frequency band, i.e., a clustered unit, according to the present invention. Further, the base station can transmit the signal by at least one cluster. That is, the base station selects at least one cluster necessary for transmitting the signal, and then determines a beam coefficient of each of the selected cluster.

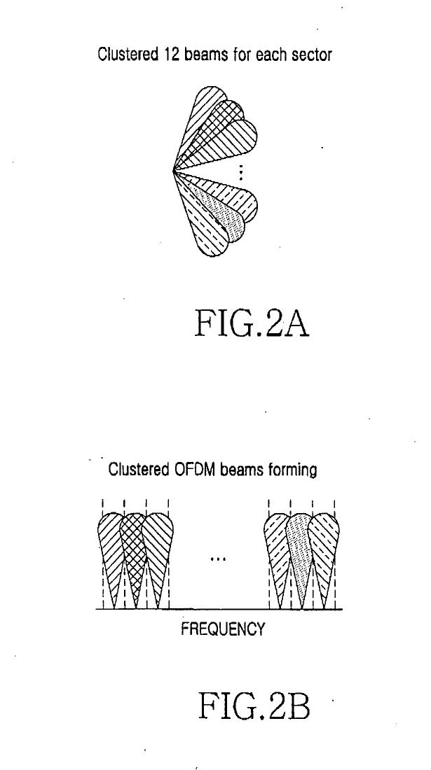

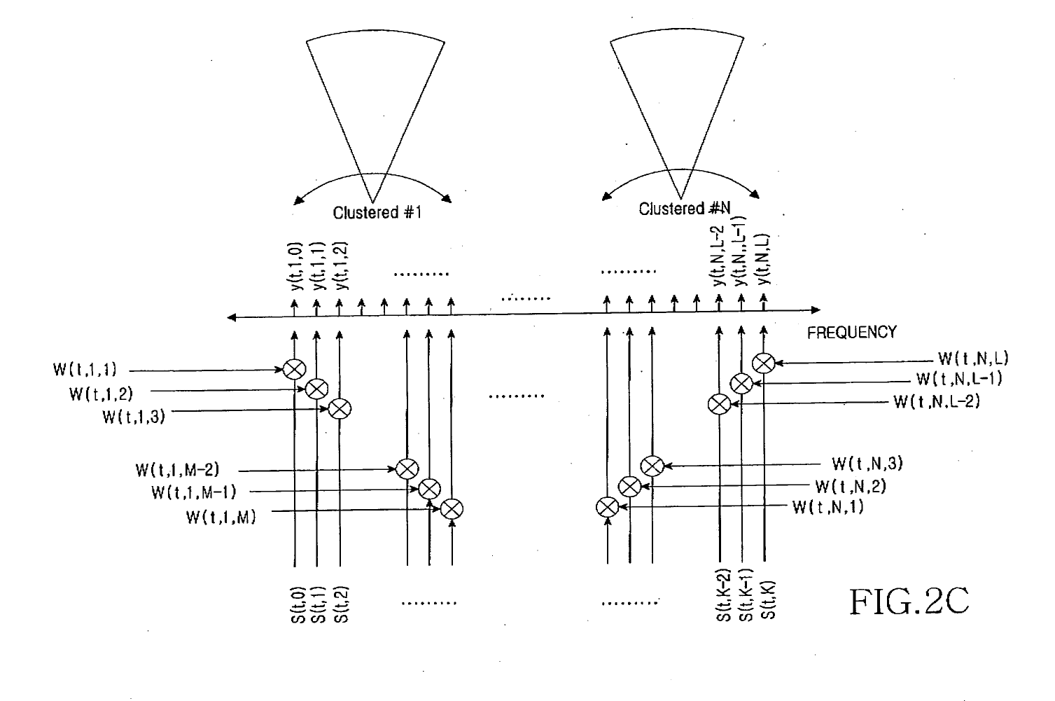

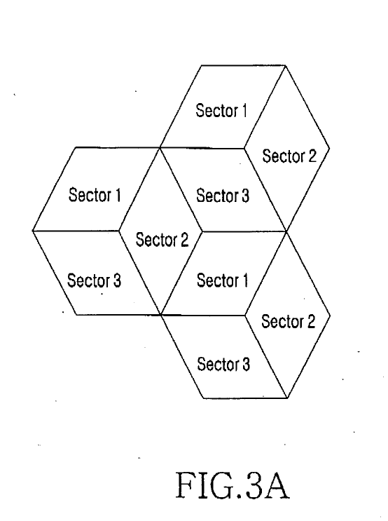

The coefficient multipliers 106-A through 106-H multiply input beam coefficients by information data to output a signal to be transmitted to the MS. Hereinafter, transmission of a clustered-beamformed signal acquired by multiplying a clustered unit by a beam coefficient will be described with reference to FIGS. 2A through 2C.

FIGS. 2A through 2C are views for explaining transmission of a clustered-beamformed signal according to an exemplary embodiment of the present invention.

FIG. 2A shows azimuth angles according to clustered beamforming, FIG. 2B shows clustered beamforming on a frequency axis, and FIG. 2C shows the implementation of clustered beamforming.

Referring to FIG. 2C, after estimating the uplink channel, the BS generates a beam coefficient for each sub-carrier using the estimated channel information. In FIG. 2C, W(t, i, j) indicates a beam coefficient, i.e., a weight vector, multiplied to an j^{th} sub-carrier in an i^{th} clustered unit at time t, S(t, k) indicates information data for each sub-carrier at time t, and y(t, i, j) indicates a transmission signal acquired by multiplying information data by the beam coefficient. Thus, y(t, i, j) can be expressed as set forth in Equation (1) below:
y(t, i, j)=S(t, k)×W(t, i, j) (1)

In FIG. 2C, the number of sub-carriers constituting each of clustered units #1 through clustered units #N may vary with a system design, and preferably, each of the clustered units #1 through # N may be composed of at least one tile or bin.

As mentioned above, if every BS forms a beam for each clustered unit to transmit a signal, an interference signal from a BS can be minimized for an MS receiving a signal from another BS. However, such a scheme cannot maximize the C/I of the MS. In other words, as the intensity of a signal from a serving BS of the MS increases, the intensity of a signal from an adjacent BS is likely to increase, which can be expressed as set forth in Equation (2) below:

$$\begin{matrix}{CIN}_{MS} = \frac{{S}_{sBS}}{{I}_{sBS} + {I}_{nBS 1} + ⋯ + {I}_{nBSm} + N} \\ \approx \frac{{S}_{BSc}}{{I}_{sBSc} + {I}_{nBSc 1} + ⋯ + {I}_{nBScm} + N} ,\end{matrix} \qquad ( 2 )$$

where S_{sBS} indicates the intensity of a signal received by an MS from a serving BS when clustered beamforming is not applied, S_{sBSc} indicates the intensity of a signal received by the MS from the serving BS when clustered beamforming is applied, I_{sBS} indicates the intensity of an interference signal received from the serving BS when clustered beamforming is not applied, I_{sBSc} indicates the intensity of an interference signal received from the serving BS when clustered beamforming is applied, I_{nBSm} indicates the intensity of an interference signal received from an adjacent BS when clustered beamforming is not applied, and I_{nBScm} indicates the intensity of an interference signal received from the adjacent BS when clustered beamforming is applied.

In other words, as can be seen from Equation 2, a C/I corresponding to a case where clustered beamforming is applied and a C/I when clustered beamforming is not applied may be equal to each other.

The present invention provides a new beam cell planning method to solve the problem.

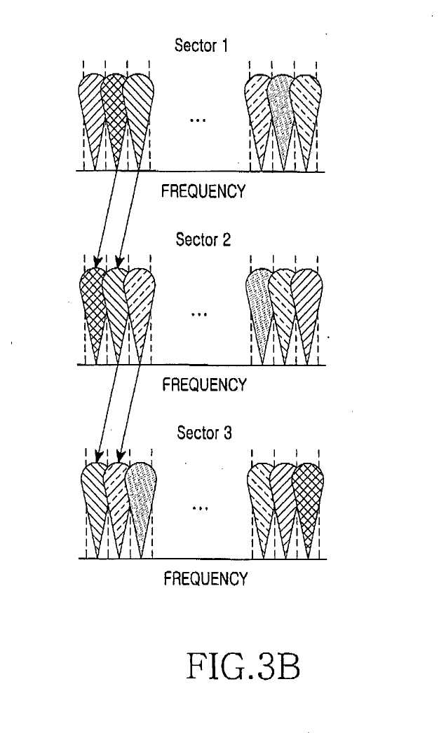

FIGS. 3A and 3B are views for explaining a beam cell planning method in a wireless communication system according to n exemplary embodiment of the present invention.

Referring to FIG. 3A, a single cell is assumed to be composed of 3 sectors. The entire frequency band is divided into a predetermined number of frequency bands, each of which is a clustered unit. Thus, if the entire frequency band is divided into N clustered units, each sector uses the N clustered frequency bands. Clustered beams of each sector are planned as illustrated in FIG. 3B. In other words, a sector 1 generates clustered beams and a sector 2 generates clustered beams by shifting the clustered beams of the sector 1 by a predetermined clustered unit. That is, it means that the beam coefficient applied to the specific cluster is applied equally to the other cluster. The beam coefficient necessary for forming the beam of each cluster (i.e., frequency band) of the sector 2 is applied by moving the beam coefficient applied to each cluster of the sector 1 by the specific cluster unit. If it is assumed that the beam coefficient W(t,i,j) in the in the Equation (1), the beam coefficient in the shifted sector 2 by m cluster can represent as W(t,I−m,j). Similarly, a sector 3 generates clustered beams by shifting the clustered beams of the sector 2 by the predetermined clustered unit.

Further, according to an exemplary embodiment of the present invention if the frequency band used in each sector is the same, i.e. the frequency reuse factor is 1, and the interference between the neighbor cells can be minimized. In addition, the exemplary embodiment of the present invention can be applied for the system having the cell that the frequency reuse factor is 1 without dividing the sector. In this case, the interference signal can be minimized by using the beam shifted by the specific cluster unit in the neighbor cell as same as the above.

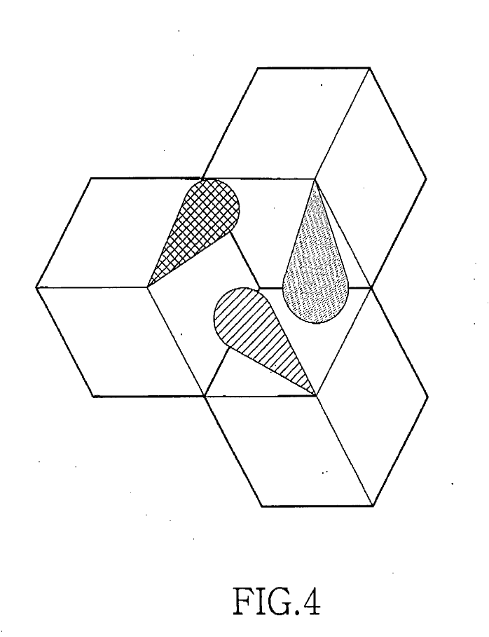

A cell may have a structure as illustrated in FIG. 4 to dispose and plan clustered beams using a scheme shown in FIG. 3B. The beam may also be formed using sub-carriers that are separated from each other. In each sector, broadcasting information may also be transmitted using clustered beams. The broadcasting information may be uniform or differ from sector to sector. Further, the broadcasting information refers to the common information or the common control information which at least one of the Mobile Stations being provided the service should be received. broadcasting information may be transmitted in a clustered frequency band #2 within the sector 3.

By planning beams as illustrated in FIG. 4, the reception C/I of the MS can be improved, which can be expressed as set forth in Equation (3) below:

$$C / {I}_{MS} = \frac{{S}_{{sBS}_{c}}}{{I}_{sBSc} + {I}_{nBSc 1} + ⋯ + {I}_{nBScm} + N} < \frac{{S}_{{sBS}_{c}}^{planning}}{{I}_{sBSc}^{planning} + {I}_{nBSc 1}^{planning} + ⋯ + {I}_{nBScm}^{planning} + N} , \qquad ( 3 )$$

S_{sBS}_{_{c}}^{planning} indicates the intensity of a signal received from the serving BS when clustered beamforming and beam cell planning are applied, I_{sBSc}^{planning} indicates the intensity of an interference signal received from the serving BS when clustered beamforming and beam cell planning are applied, and I_{nBScm}^{planning} indicates the intensity of an interference signal received from the adjacent BS when clustered beamforming and beam cell planning are applied.

As can be seen from Equation (3), the intensity of a signal received from the serving BS satisfies S_{sBS}_{_{c}}^{planning}=S_{sBSc} regardless of whether beam cell planning is applied, whereas the intensity of an interference signal received from the adjacent BS satisfies I_{nBScm}>I_{nBScm}^{planning}. Thus, as the intensity of an interference signal received from the adjacent BS decreases, the reception C/I of the MS increases, which means an increase in a possibility that the MS can normally receive a signal. Even when a shadow area, which clustered beams cannot reach is generated, the same information is transmitted through other clustered increases, which means an increase in a possibility that the MS can normally receive a signal. Even when a shadow area, which clustered beams cannot reach is generated, the same information is transmitted through other clustered beams using the most robust Modulation and Coding Scheme (MCS) level and thus the shadow area can be easily removed.

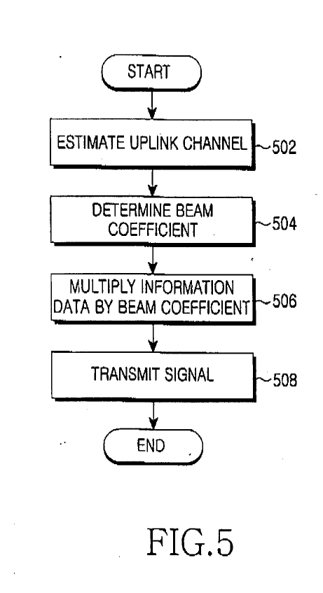

FIG. 5 is a flowchart illustrating a process in which a BS transmits a signal using clustered beamforming according to an exemplary embodiment of the present invention.

Referring to FIG. 5, the BS estimates an uplink channel using a signal received from an MS in step 502. The BS then determines a beam coefficient for each sub-carrier of a clustered unit in step 504. In step 506, the BS multiplies information data for each sub-carrier by the determined beam coefficient. In step 508, the BS transmits a signal resulting from the multiplication to the MS.

Meanwhile, the present invention can use the predetermined beam coefficient for each cluster. Herein, the predetermined beam coefficient for each cluster can be included in the common information.

As described above, the present invention can minimize an interference signal received from an adjacent BS by applying new clustered beamforming and beam cell planning to a wireless communication system. In particular, the

While the invention has been shown and described with reference to an exemplary embodiment thereof, it will be understood by those skilled in the art that various changes in form and details may be made therein without departing from the spirit and scope of the invention as defined by the appended claims.

What is claimed is:

1. A method for transmitting a signal by a Base Station (BS) having multiple antennas in a wireless communication system using multiple carriers, the method comprising:
selecting at least one predetermined frequency sub-band;
determining a beam coefficient for each of sub-carriers constituting each of the selected frequency sub-bands;
forming a beam for the selected frequency sub-band by multiplying each sub-carrier by the beam coefficient; and
transmitting a signal to a Mobile Station (MS) using the formed beam.

2. The method of claim 1, further comprising estimating an uplink channel using a signal received from the MS.

3. The method of claim 1, wherein the beam coefficient is determined based on an estimated uplink channel.

4. The method of claim 1, wherein a predetermined frequency band is one of a tile and a bin that is a set of a plurality of sub-carriers.

5. A method for transmitting a signal in a wireless communication system using an equal frequency band in at least one cell or sector, the method comprising:
dividing an entire frequency band into a predetermined number of N frequency sub-bands;
estimating an uplink channel using a signal received from a Mobile Station (MS);
determining beam coefficients for each of sub-carriers of each of the N frequency sub-bands used in a first cell or sector based on the estimated uplink channel and forming N beams in the first cell or sector by multiplying each sub-carrier by the beam coefficients; and
applying the determined beam coefficients to the frequency sub-bands by shifting sequence of the frequency sub bands in a second cell or sector.

6. The method of claim 5, wherein the beam coefficients in the second cell or sector is formed by multiplying each of the shifted sub-carriers of each frequency sub-band by the beam coefficients determined in the first cell or sector.

7. The method of claim 5, wherein the frequency sub-band is one of a tile or a bin that is a set of a plurality of sub-carriers.

8. The method of claim 5, wherein the signal is common information transmitted in at least one cell or sector.

9. A method for transmitting a signal in a wireless communication system using an equal frequency band (where a frequency reuse factor is 1) in at least one cell or sector, the method comprising:
forming beams in a first cell or sector by applying each predetermined beam coefficient to sub-carriers in each predetermined frequency su-band; and
applying the each predetermined beam coefficient in a second cell or sector to the each predetermined frequency sub band by shifting sequence of the predetermined frequency sub-band,
wherein the predetermined frequency sub-band is divided from an entire frequency band to a number of predetermined frequency sub-bands, and each frequency sub-band is composed of at least one sub-carrier.

10. The method of claim 9, wherein the predetermined frequency sub-band is one of a tile or a bin that is a set of a plurality of sub-carriers.

11. The method of claim 9, wherein the signal is common information that is transmitted in at least one cell or sector.

12. An apparatus for transmitting a signal by a Base Station (BS) having multiple antennas in a wireless communication system using multiple carriers, the apparatus comprising:
a channel estimator for estimating an uplink channel;
a beam coefficient generator for generating a beam coefficient to minimize interference between cells based on estimated uplink channel; and
a coefficient multiplier for forming a beam for the selected frequency sub-band by multiplying each sub-carrier by the beam coefficient,
wherein the beam coefficient is determined for each of sub-carriers constituting each of frequency sub-bands.

13. The apparatus of claim 12, wherein the frequency sub-band includes at least one sub-carrier.
